(19) United States
(12) Patent Application Publication
(10) Pub. No.: US 2012/0265659 A1
(43) Pub. Date: Oct. 18, 2012

(54) LOAN REPORTING ASSOCIATED WITH REAL ESTATE

(75) Inventors: Susan M. Smith, Oswego, IL (US); Lifeng Chen, Charlotte, NC (US); Kathleen J. Perugini, Cheshire, CT (US); William M. Satkevich, Bourne, MA (US); Joseph E. Frisk, Uxbridge, MA (US); Deborah R. Vahlkamp, Timonium, MD (US)

(73) Assignee: BANK OF AMERICA LEGAL DEPARTMENT, Charlotte, NC (US)

(21) Appl. No.: 13/088,748

(22) Filed: Apr. 18, 2011

(51) Int. Cl. G06Q 40/00

(52) U.S. Cl. 705/35

(57) ABSTRACT

Aspects described herein provide techniques for providing information on real estate loans. First user input indicating a request for identifying at least one exception for data elements associated with at least one real estate loan may be received. The at least one exception may be representative of a conditionally acceptable data element value or an unacceptable data element value. Data for the at least one real estate loan may be compared with business rules data concerning unconditionally acceptable values of the data. The at least one exception may be identified based upon the comparison. Second user input indicating one of a verification of the at least one exception for the conditionally acceptable data element value or a change of the value for the at least one exception for the unacceptable data element value may be received.

### FIELD OF THE TECHNOLOGY

Aspects of the present disclosure relate generally to an automated system for monitoring and providing information on real estate loans offered by a financial institution. More specifically, aspects of the present disclosure provide ways of monitoring data, analyzing data, allowing the correction of data, and generating an analytic report based on a specified type of real estate loan offered by a financial institution.

### BACKGROUND

A financial institution offers many types of real estate loans to its customers. These customers may be individuals, private customers, or commercial customers. Concern over the real estate loans offered by a financial institution may occur. The financial entity or a governmental entity may inquire as to the details of the real estate loans to confirm the financial viability of the financial institution.

### BRIEF SUMMARY

In light of the foregoing background, the following presents a simplified summary of the present disclosure in order to provide a basic understanding of some illustrative aspects. This summary is not an extensive overview. It is not intended to identify key or critical elements or to delineate the scope of the illustrative embodiments. The following summary merely presents some concepts of the illustrative embodiments in a simplified form as a prelude to the more detailed description provided below.

There is a need, therefore, for a financial entity to be able to generate analytic reports concerning real estate based loans it provides. Various divisions within a financial institution may offer vastly differing real estate based loans. As such, reports needed by each division may be vastly different. These reports may be used internally by a financial institution to monitor real estate loans it provides, or in some cases, may be required by governmental agencies in the course of monitoring the viability of the financial institution.

One or more aspects described herein provide techniques for monitoring and providing information on real estate loans offered by a financial institution. More specifically, these techniques provide ways of monitoring data, analyzing data, allowing the correction of data, and generating an analytic report based on a specified type of real estate loan. While some of the real estate loans offered by a financial institution pose little risk to the financial institution, many pose significant risk to the financial viability of the financial institution. One or more of the aspects described herein provide a system and method for a financial institution to monitor the aggregated risk posed to the financial institution by real estate loans.

As aspects of the disclosure are flexible and scalable, they may be used by various divisions within a financial institution and may generate customized reports for each division. In addition, the disclosure may support generation of reports required by governmental agencies, and the flexibility enables it to modify reports based on changes in governmental report requirements.

In the following, by way of illustration, generation of a report related to real estate loans based, in part, on Commercial Real Estate (CRE) is described. The use of this illustrative embodiment does not limit the scope of this disclosure.

Aspects of the disclosure may be provided in one or more tangible computer-readable medium storing computer-executable instructions that, when executed by one or more processors, cause a computer or other apparatus to perform one or more of the operations described herein.

### BRIEF DESCRIPTION OF THE DRAWINGS

The present disclosure is illustrated by way of example and is not limited in the accompanying figures in which like reference numerals indicate similar elements and in which:

FIG. 1 is an illustrative embodiment of real estate loan data elements and business rules data items in accordance with at least one aspect of the present disclosure.

FIG. 2 is an illustrative block diagram of a system for generating a report based on real estate loans offered by a financial institution in accordance with at least one aspect of the present disclosure.

FIG. 3 is an illustrative architecture implementation of computers and servers for operation of a system for generating a report based on real estate loans offered by a financial institution in accordance with at least one aspect of the present disclosure.

FIG. 4 is an illustrative signaling diagram of communications between a data input/report request server, financial server, loan data memory, and business rules data memory in accordance with at least one aspect of the present disclosure related to data population.

FIG. 5 is an illustrative signaling diagram of communications between a data input/report request server, financial server, loan data memory, and business rules data memory in accordance with at least one aspect of the present disclosure related to report generation.

FIG. 6 is an illustrative method in a financial server for generating a report based on real estate loans offered by a financial institution in accordance with at least one aspect of the present disclosure.

FIG. 7 is an illustrative embodiment of a real estate loan report output page in accordance with at least one aspect of the present disclosure.

FIG. 8 is a flowchart of an illustrative method for generation of a report based on real estate loans offered by a financial institution in accordance with at least one aspect of the present disclosure.

FIG. 9 is an illustrative user interface for searching for and identifying exceptions of real estate loans offered by a financial institution in accordance with at least one aspect of the present disclosure.

FIG. 10 is an illustrative user interface for reviewing and editing exceptions of a real estate loan offered by a financial institution on a particular real estate facility in accordance with at least one aspect of the present disclosure.

FIGS. 11-13 are illustrative user interfaces for loan details of a real estate loan offered by a financial institution on a particular real estate facility in accordance with at least one aspect of the present disclosure.

FIGS. 14-16 are illustrative user interfaces for reviewing and editing exceptions to data elements of a real estate loan offered by a financial institution on a particular real estate facility in accordance with at least one aspect of the present disclosure.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

Illustrative embodiments described herein provide for generating reports based on real estate loans provided by a financial institution to its customers. In these illustrative embodiments, the real estate loans to be included in the report may be ones in which Commercial Real Estate (CRE) is involved. This involvement may comprise the use of CRE as collateral to secure a real estate loan or the purchase of CRE may be the reason a real estate loan is sought from a financial institution.

In an illustrative embodiment, the financial institution may prepare in advance for the generation of a report by populating real estate loan related data in a database. The financial institution may also populate real estate loan related business rules data in a database.

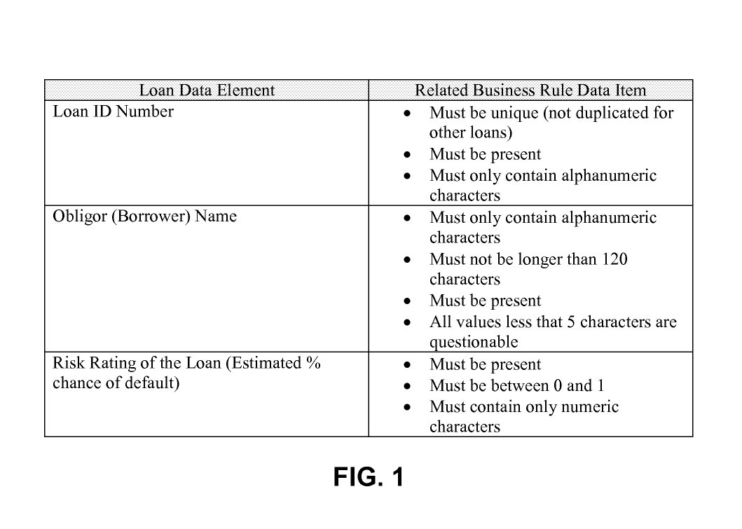

FIG. 1 illustrates an illustrative embodiment of real estate loan data and the associated business rules data. The use of this illustrative embodiment does not limit the scope of the real estate loan based data nor business rules data disclosed herein.

At times, some of the real estate loan data may be incomplete or some facet of the real estate loan data might not align with the stored business rules data. As an illustrative example, while a report is being generated, it may be discovered that the Risk Rating of the Loan of a real estate loan was incorrectly stored as a number greater than 1 (reference FIG. 1). In that case, the particular real estate loan can be quickly identified and input may be solicited from a member of the financial institution.

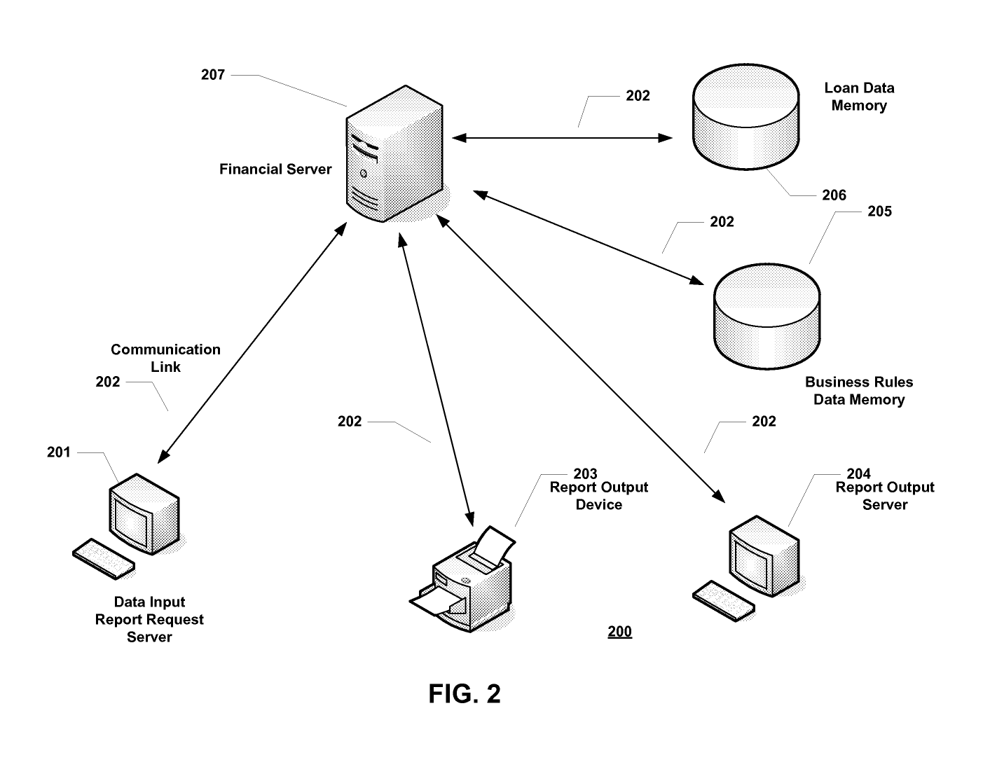

FIG. 2 illustrates an illustrative block diagram of a system 200 for generating reports on real estate loans based on Commercial Real Estate (CRE). A financial server 207, a data input/report request server 201, a report output device 203, a report output server 204, a business rules data memory 205, and a loan data memory 206 may be communicatively coupled via communication links 202. The communication links 202 may be comprised of a local area network (LAN), a wide area network (WAN), as well as one or more other networks or combination of networks. It will be appreciated that the communication links shown are illustrative and other means of establishing communication between the components may be used. Any of various well-known protocols such as TCP/IP, Ethernet, FTP, HTTP and the like may be used.

The financial server 207, data input/report request server 201, and report output server 204 may be servers provided by banks or other financial institutions. The loan data memory 206 and business rules data memory 205 may be provided by a bank, another financial institution, or a third party provider. The memories 205 and 206 may be located locally, remotely, or a combination of the two. The report output device 203 may be a server similar to report output server 204 or a device dedicated to output such as a printer, video screen, or other similar device. It is noted that FIG. 2 depicts a single instance of each of the data input/report request server 201, report output device 203, report output server 204, business rules data memory 205, loan data memory 206 and financial server 207; however, system 200 may include multiple instances of each of these devices. Moreover, the functions described as being performed by these devices may be subdivided or aggregated into more or fewer devices.

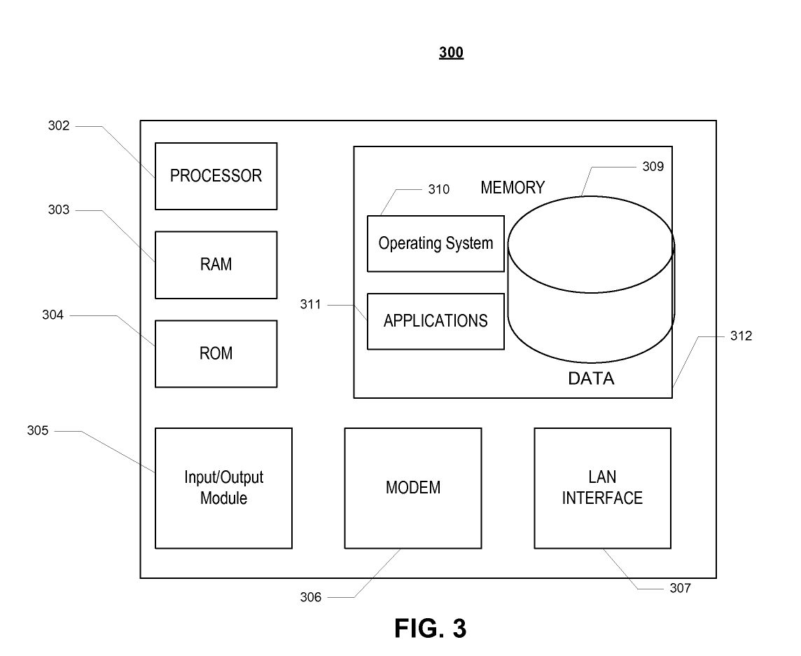

FIG. 3 illustrates an illustrative architecture implementation of servers depicted in system 200. Some or all of the architecture components of server 300 described in FIG. 3 may be implemented in each of the financial server 207, the data input/report request server 201, and/or the report output server 204. In an illustrative embodiment, the server 300 may have a processor 302 for controlling its overall operation and its associated components, including RAM 303, ROM 304, input/output module 305, and memory 312. The server 300 may operate in a networked environment supporting connections to one or more remote servers or memory apparatus using a modem 306 or LAN interface 307. Processor 302 and its associated components may run a series of computer-readable instructions to cause the server 300 to perform the operations described herein.

Input/Output (I/O) 305 may include a microphone, keypad, touch screen, and/or stylus though which a user of server 300 may provide input, and may also include one or more of a speaker for providing audio output and a video display device for providing textual, audiovisual, and/or graphical output. Software may be stored within memory 312 to provide instructions to processor 302 for performing various functions. For example, memory 312 may store software such as an operating system 310, application programs 311, and an associated database 309.

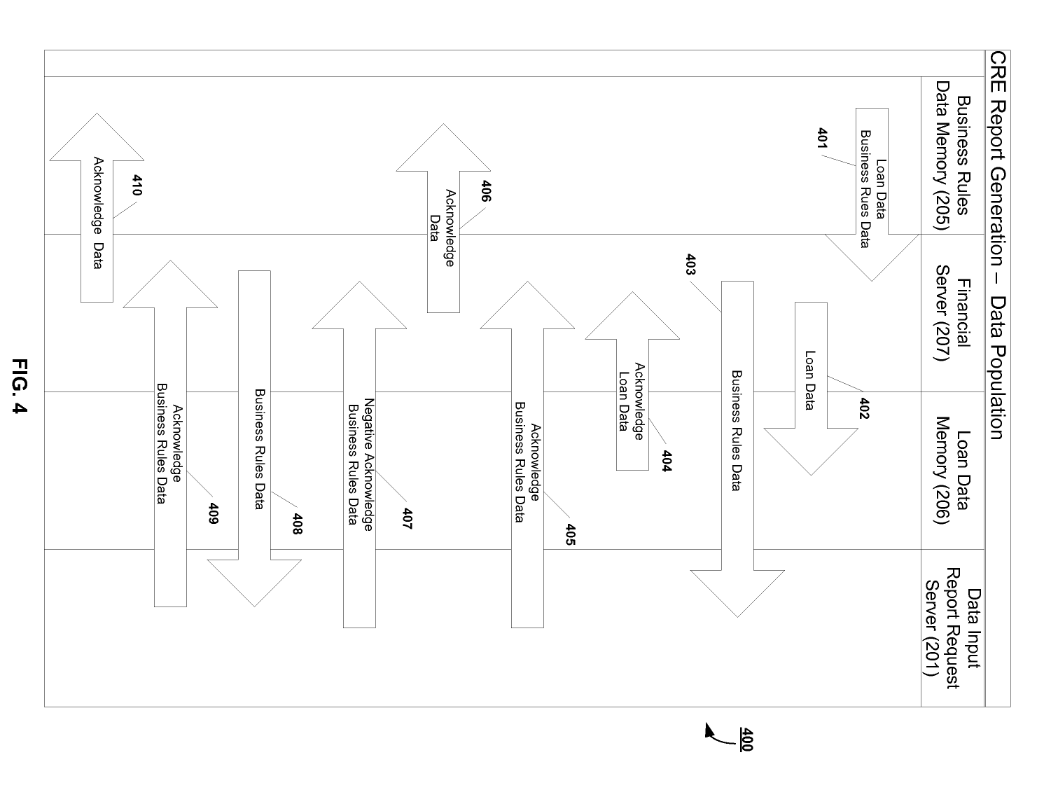

FIG. 4 (401 through 406) illustrates an illustrative signaling diagram of communications between data input/report request server 201, financial server 207, loan data memory 206, and business rules data memory 205 for the case in which the data transfer is successful. Successful data transfer may be determined by methods such as parity or any other method mutually understood by financial server 207, loan data memory 206 and business rules data memory 205. This method is applicable to at least initial data population as well as population of ongoing data changes/updates.

Initially, one or more data input/report request servers 201 may communicate real estate loan and business rules data 401 to financial server 207. This data may include all data available about various real estate loans as well as business rules data. In response to receiving the real estate loan and business rules data, the financial server may parse the data and send the real estate loan data 402 to loan data memory 206 and send business rules data 403 to business rules data memory 205. By way of example, these two memories are shown as individual devices. However, the functions being performed by these devices may be subdivided or aggregated into more or fewer devices.

According to an illustrative aspect, loan data memory 206 and business rules data memory 205 may advantageously acknowledge successful receipt of data by sending acknowledgements 404 and 405 to financial server 207. Data acknowledged by 404 and 405 may be identified by time stamp or by any other method mutually understood by loan data memory 206, business rules data memory 205, and financial server 207. Acknowledgements 404 and 405 may be sent on a periodic time basis, after a predetermined amount of data has been transferred, or by any other method mutually understood by loan data memory 206, business rules data memory 205, and financial server 207.

In response to receiving acknowledgements 404 and/or 405, financial server 207 may send acknowledgement 406 to data input/report request server 201. Acknowledgement 406 may be sent as acknowledgement of real estate loan data receipt, business rules data receipt, or a combination of the two. In addition, acknowledgement 406 may be sent on a periodic time basis, after a predetermined amount of data has been transferred, or by any other method mutually understood by data input/report request server 201 and financial server 207.

FIG. 4 (407 through 410) illustrates an illustrative signaling diagram of communications between financial server 207 and business rules data memory 205 for the case in which the data transfer is unsuccessful. Unsuccessful data transfer may be determined by methods such as parity or any other method mutually understood by financial server 207 and business rules data memory 205. For illustrative purposes, FIG. 4 (407 through 410) presents an example comprising financial server 207 and business rules data memory 205. This illustrative method also applies to data transfer additionally involving data input/report request server 201 and loan data memory 206. In an illustrative embodiment, when business rules data memory 205 determines that an unsuccessful data transfer has occurred, business rules data memory 205 may advantageously send a negative acknowledgement 407 to financial server 207. Data negatively acknowledged by 407 may by identified by time stamp or by any other method mutually understood by business rules data memory 205 and financial server 207.

Upon receipt of negative acknowledgement 407, financial server 207 may retransmit, 408, the data that had been negatively acknowledged by 407. Data to be retransmitted may be identified by time stamp or by any other method mutually understood by business rules data memory 205 and financial server 207. When the retransmitted data has been successfully received by business rules data memory 205, steps 409 and 410, which are analogous to steps 405 and 406, are followed.

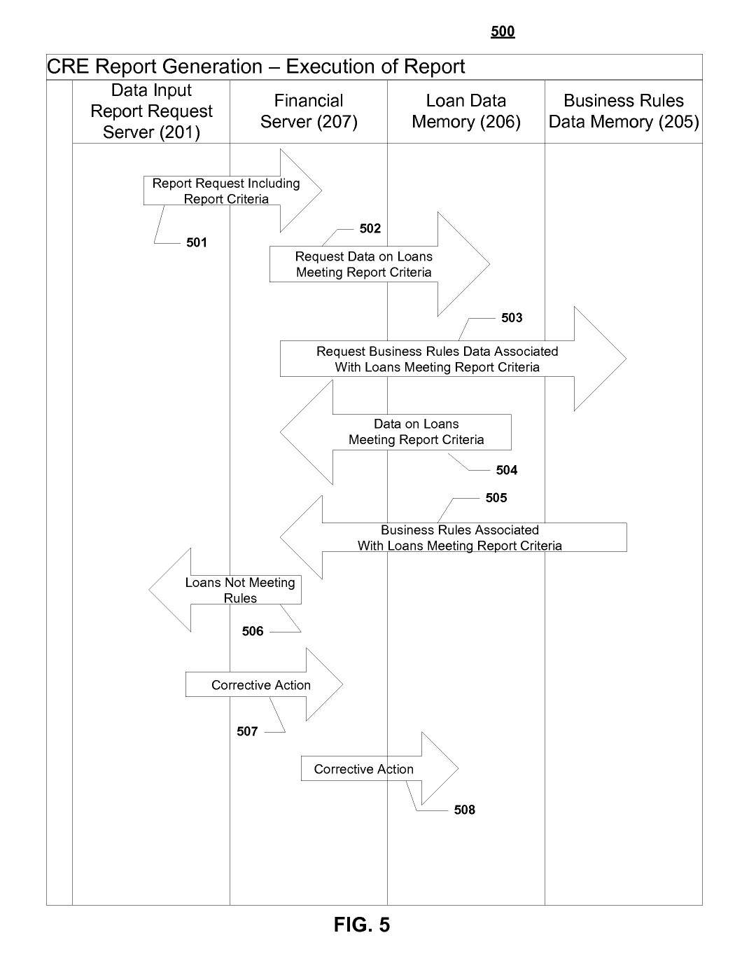

FIG. 5 illustrates an illustrative signaling diagram between data input/report request server 201, financial server 207, loan data memory 206, and business rules data memory 205 for the case in which a report is to be generated. Initially, one or more data input/report request servers 201 communicate a request for a report 501 to financial server 207. Advantageously, the data input/report request server specifies the type of report requested. According to an illustrative aspect, data input/report request server may request a report detailing real estate loans with CRE for collateral, real estate loans to be used for the ultimate purchase of CRE, or any other financial criteria.

In response to receiving the request for report generation, the financial server 207 will formulate queries (502 for data on real estate loans and 503 for data on business rules) containing criteria for report generation and send these queries to the loan data memory 206 and the business rules data memory 205. By way of example, these two memories are shown as individual devices. However, the functions being performed by these devices may be subdivided or aggregated into more or fewer devices.

According to an illustrative aspect, loan data memory 206 and business rules data memory 105 may advantageously return to the financial server 207 data 504 and 505 based on criteria included in queries 502 and 503. Data is returned in 504 and 505 in either one record per message, an aggregation of many records per message, or any other method mutually understood by financial server 207, loan data memory 206, and business rules data memory 205.

Upon reception of data 504 and 505, financial server 207 may compare the data for each real estate loan returned from loan data memory 206 with the business rules data returned from business rules data memory 205. Financial server 207 may then identify real estate loans whose data does not comply with the business rules data.

Advantageously, financial server 207 sends information 506 concerning noncompliant real estate loans or real estate loans with missing data to data input/report request server 201. According to an illustrative aspect, a member of the financial institution may retrieve the information concerning the noncompliant real estate loans and real estate loans with missing data in order to instruct 507 the financial server 207 how to proceed. As an example, the possible instructions include but are not limited to supplying missing data, resolving the noncompliance, or removing the particular real estate loan from the report. Also contained in 507, if it is deemed appropriate by the member of the financial institution, is an indication to financial server 207 to update the data in loan data memory 206 via 508.

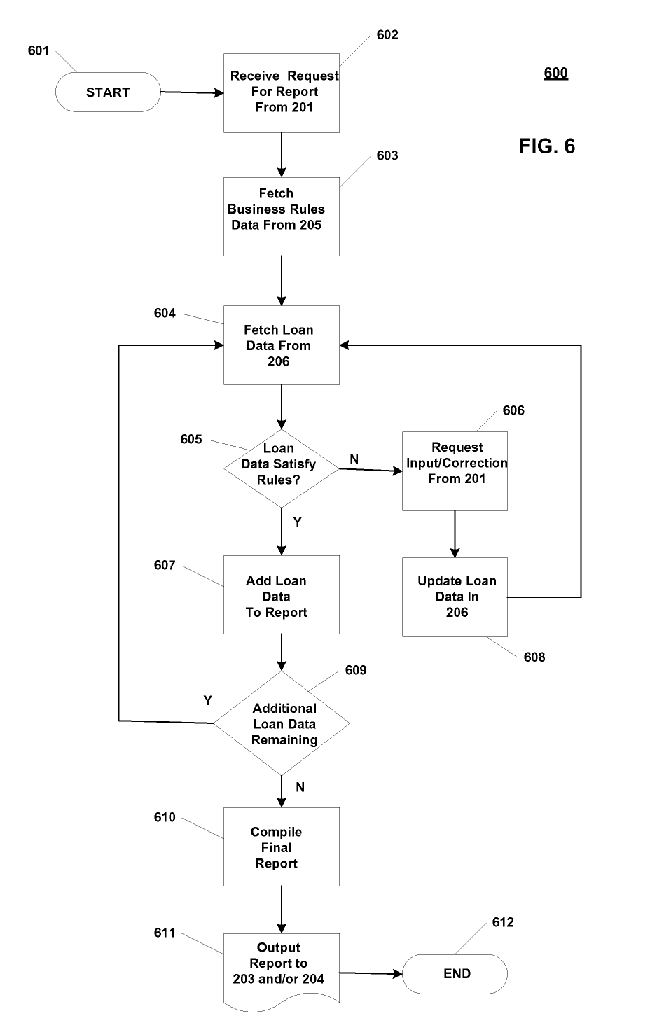

FIG. 6 illustrates an illustrative method of generating a report in the financial server 207 in accordance with illustrative embodiments of the present disclosure. The illustrative method may begin at block 602. In block 602, the method may include receiving a request to generate a report on real estate loans associated with CRE.

603 and 604 may include fetching real estate loan and business rule data from respectively loan data memory 206 and business rules data memory 205. The fetching of the data may be on a per real estate loan/business rule basis, on the basis of aggregating multiple records in a single fetch operation, or any other method mutually understood by the financial server 207, the loan data memory 206, and the business rules data memory 205.

605 may include the financial server 207 comparing the data related to each real estate loan with the set of business rules data. If the real estate loan data is compliant with the rules data, the data for the compliant real estate loan may be added to the report 607. If the data is not compliant, the financial server may request input/corrections 606 from a member of the financial institution. The updated real estate loan data may be entered back 608 into the loan data memory 206.

Financial server 207 may continue this method until it has analyzed all data 609 for the real estate loans conforming to the criteria that may have been contained in the initial request for the report 602. The final form of the report may then be compiled 610 and the report may be delivered in a user readable form 611.

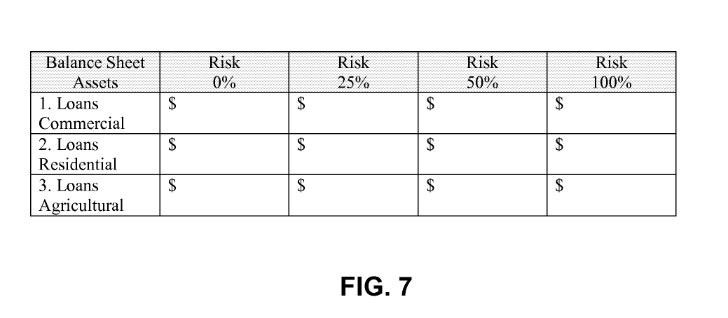

FIG. 7 illustrates an illustrative embodiment of a report generated. The use of this illustrative embodiment does not limit the scope of the report generated as disclosed herein.

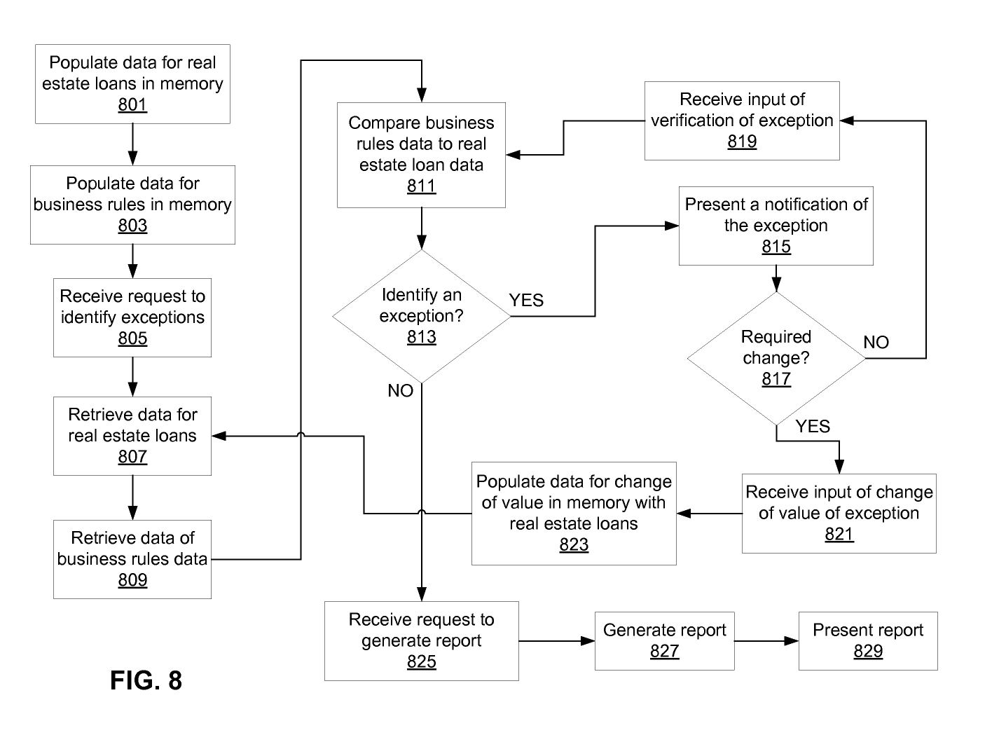

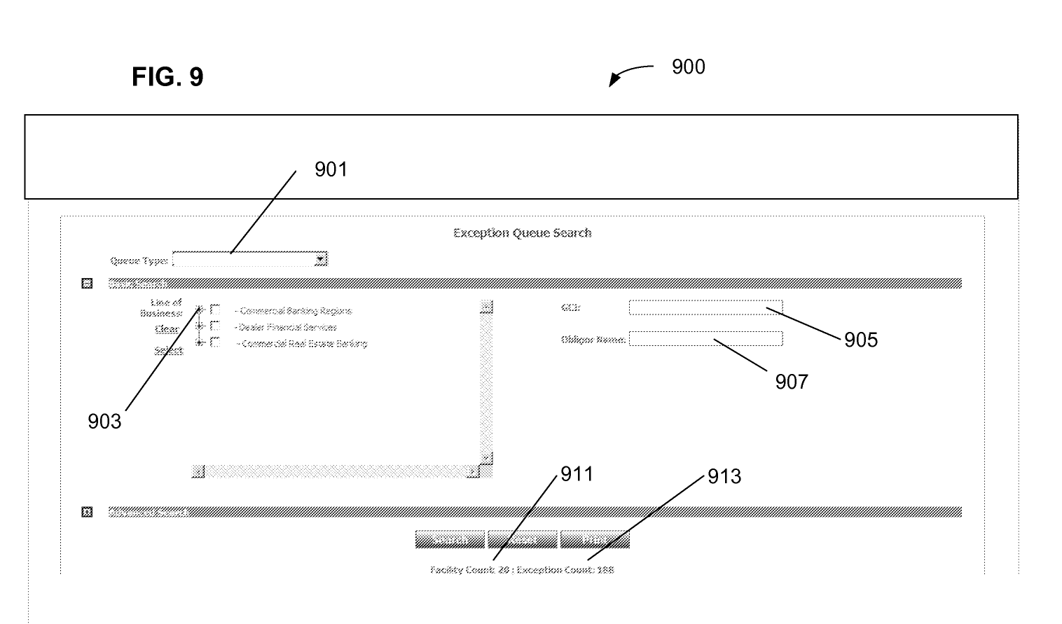

FIG. 8 is a flowchart of an illustrative method for generation of a report based on real estate loans offered by a financial institution in accordance with at least one aspect of the present disclosure. The process starts and at 801, data for one or more real estate loans may be populated in a memory. The process of 801 may be implemented by financial server 207 as shown in FIG. 2. The memory may be loan data memory 206 as shown in FIG. 2. The data populated in 801 may be for a plurality of the real estate loans offered by a financial institution. Because the plurality of real estate loans offered by the financial institution may be maintained in a plurality of different external memories, the step of populating the data in 801 may be populating the data from a plurality of different databases. The process of populating in 801 may be an automated process by one or more computers. An illustrative example of data for one or more real estate loans populated in a memory, such as in 801, is shown in FIG. 1. As described in more detail with respect to FIGS. 9-16, any of a number of data elements with respect to one or more real estate loans may be included in memory 801 and/or utilized in accordance with one or more aspects of the present disclosure.

At 803, business rules data may be populated in a memory. The memory may be business rules data memory 205 as shown in FIG. 2. The process of 803 may be implemented by financial server 207 as shown in FIG. 2. The data populating 803 may be for a plurality of business rules implemented by the financial institution. Because the plurality of business rules implemented by the financial institution may be maintained in a plurality of different external memories, the step of populating the data in 803 may be populating the data from the plurality of different databases. The process of populating in 803 may be an automated process by one or more computers. An illustrative example of data for one or more business rules populated in a memory, such as in 803, is shown in FIG. 1. Any of a number of different business rules may be implemented with respect to one or more data elements.

For example, data with respect to a business rule may require that for a particular data element, the entry must be a unique entry, e.g. not duplicated for any other entry, must contain alphanumeric characters, must have a threshold number of characters, whether a maximum threshold, a minimum threshold, or both, must be one of a select option of entries, e.g., yes or no, 1, 2, or 3, and high, medium, or low, etc. Such business rules data may include unconditionally acceptable values for one or more data elements of real estate loans offered by the financial institution. For example, a business rule for a particular data element may be a requirement for entry of yes or no. In such an example, an entry of yes or no, when compared to the business rule, would be an unconditionally acceptable value. Thus, the business rule would be met and, as described in more detail herein, no exception to the business rule would be identified. In the same example, if the entry was blank, the business rule expecting an entry of yes or no would not be met and, as described in more detail herein, an exception to the business rule would be identified. This exception may require a change of entry and/or may request a verification of the identified exception.

Proceeding to 805, a request to identify one or more exceptions may be received. The process of 805 may be implemented by financial server 207 as shown in FIG. 2. The request may be a user input indicating a request for identifying one or more exceptions for data element values associated with one or more real estate loans offered by a financial institution. The request for identifying one or more exceptions may include particular information such as a particular real estate loan, a particular group of real estate loans, and/or all real estate loans. An exception for a data element value may be an indication that an entered data element value does not comply with the business rule implemented by the financial institution. As described herein, an exception may be an indication that the data element value is a blank data element when the business rule requires an entry, the data element value is a conditionally acceptable data element value when the that the entry is different than what is expected and verification of the entry may be needed, and/or the data element value is an unacceptable data element value when that the entry is not correct. A blank data element value may be an unacceptable data element value.

FIG. 9 is an illustrative user interface 900 for searching for and identifying exceptions of real estate loans offered by a financial institution in accordance with at least one aspect of the present disclosure. User interface 900 provides many manners for searching for and/or identifying exceptions for real estate loans. For example, a drop-down box 901 allows a user to select among different queue types. A queue type may be a limitation on searches with respect to a particular user, a particular group or category of real estate, and/or other data. Data 903 may correspond to a hierarchy system where a user may drop down within a particular category for searches with respect to exceptions for real estate loans. Data field 905 may allow for entry of the GCI account associated with one or more real estate loans. Finally, data field 907 may allow for entry of an obligor name associated with one or more real estate loans. As should be understood, FIG. 9 is but one illustrative user interface of any of a number of different search criteria may be utilized in accordance with one or more aspects of the present disclosure.

Returning to FIG. 8 and moving to 807, data for one or more real estate loans specified in the request may be retrieved. The process of 807 may be implemented by financial server 207, as shown in FIG. 2, retrieving the data from loan data memory 206 via communications link 202. If the request to identify exceptions in 805 is a request to a limited group of real estate loans data, the process of 807 may be implemented only with respect to the limited group. However, the process of 807 may be a process to retrieve all data for all real estate loans offered by the financial entity. The data retrieved for real estate loans in 807 may be one or more data elements associated with one or more real estate loans. In 809, data for one or more business rules may be retrieved. The process of 809 may be implemented by financial server 207, as shown in FIG. 2, retrieving the data from business rules data memory 205 via communications link 202. The retrieved data for one or more business rules in 809 may be data corresponding to unconditionally acceptable values of the data for the one or more real estate loans in the request in 805. As such, if the request to identify exceptions in 805 is a request to a limited group of real estate loans data, the process of 809 may be implemented only with respect to the limited group, e.g., only business rules data applicable to the real estate loans of the limited group may be retrieved.

In 811, a comparison of the business rules data retrieved in 809 to the real estate loans data retrieved in 807 may be implemented. The process of 811 may be implemented by financial server 207, as shown in FIG. 2. As illustrated in FIG. 1, a single data element, such as “Loan ID Number,” may have a plurality of business rules, e.g., three, associated therewith. Any number of business rules may be associated with any number of data elements. The comparison of business rules data to the real estate loans data in 811 is a comparison between the entered data for the real estate loan data in comparison to the business rules associated with it. The comparison in 811 reviews data formatting and determines allowable values. In addition one or more data elements may be compared with each other as part of business rules data to ensure consistency and/or accuracy. The comparing step in 811 may include comparing a data element value for a current period of time, such as the value for a third quarter of a financial institution's billing year, to the data element value for a previous period of time, such as the value for a second quarter of the financial institution's billing year. An unexpected change in the current value from a previous value for the data element may indicate an incorrect entry. For example, an origination date for a real estate loan should not change from one period of time to another, while an interest rate may change due to refinancing. As such, a comparison of the value for the origination date data element for a current period of time to the value for the origination date data element for a previous period of time may identify an inaccurate entry for the current period of time. As such, as described in more detail herein, a verification of the value and/or change of value may be requested/required.

Proceeding to 813, a determination may be made as to whether one or more exceptions have been identified. As described herein, an exception may be a determination that an entry for a data element of a real estate loan conditionally meets a business rule, fails to meet a business rule, and/or is blank. FIG. 9 illustrates an illustrative example for identified exception. As shown, a total number of identified exceptions are shown as “188” in reference element 913. Additional data associated with one or more exceptions may also be identified. For example, reference element 911 identifies that the total number of identified exceptions are with respect to “20” real estate facilities. Reference elements 911 and 913 are illustrative types of notification as described in more detail herein.

If no exceptions are identified in 813, the process proceeds to 825. If one or more exceptions are identified in 813, the process moves to 815 where a notification of the at least one exception may be presented. The presentation of the notification in 815 may be a visual, audio, and/or combination notification. For example, a user interface may provide one or more details of the identified exception. For a plurality of identified exceptions, a plurality of similar and/or different notifications may be provided. Still further, in conjunction with providing a notification of an exception, in 815, a notification of meeting a business rule may be identified. As such, a user may be able to discern quickly data element value entries that require user verification and/or modification and data element value entries that have been confirmed by the system to have met the business rules.

Moving to 817, a determination may be made as to whether a required change is needed with respect to the identified exception. The process of 817 may be implemented by financial server 207 as shown in FIG. 2. For example, a determination may be made by the system in the comparison of 811 that the identified exception in 813 is a fatal exception. A fatal exception may be one in which an authorized user is required to enter a change of the data element value in order to meet at least one business rule associated with the data element. In such an example, a fatal exception may prevent a user from outputting a report indicating a completion of review of data associated with the real estate loan. As such, the system may ensure that conformance to a business rule is met. Alternatively, a change to the data element value entry may not be required. For example, the system may request verification of the data element value entry that does not meet one or more business rules associated with the data element. Such an example may be a situation in which a user is authorized to override a business rule associated with the data element.

If changes are not required in 817, the process moves to 819 where a user input may be received. The process of 819 may be implemented by financial server 207 as shown in FIG. 2. The user input may be a verification of the at least one exception for the data element value. For example, the user input may be a confirmation by an authorized individual that the entered data element value, although not meeting at least one business rule associated with the data element, is verified as accurate. The process may then proceed back to 811 where the system may note for subsequent comparison that the failure to comply with at least one business rule of a particular data element has been verified by an authorized user. If changes to a data element value are required in 817, the process may proceed to 821 where a user input may be received. The process of 821 may be implemented by financial server 207 as shown in FIG. 2. The user input may be a change of the value for the data element value. For example, if the identified exception is a fatal exception, in 821, an authorized user may be required to enter a change of the data element value in order to meet one or more business rules associated with the data element. The process may then proceed to 823 where data for the change of the value for one or more data elements may be populated in a memory. The process of a 23 may be implemented by financial server 207 as shown in FIG. 2. The memory may be loan data memory 206 is shown in FIG. 2. The process may then return to 807.

In 825, an input to generate a report may be received. The input may be a report request for generation of report on the status of one or more real estate loans of the plurality of real estate loans offered by the financial institution. The process of 825 may be implemented by financial server 207 as shown in FIG. 2. In the illustrative example of FIG. 8, the process of 825 may be implemented only after all identified exceptions have been accounted for by the system. In other illustrative examples not shown, a request to generate a report and/or generation and presentation of such a report may be received and/or implemented even with one or more identified exceptions still unaccounted for. Proceeding to 827, a report as specified in the request may be generated. The process of 827 may be implemented by financial server 207 as shown in FIG. 2. Moving to 829, the report may be presented in a user readable form. User readable form may include data for a user interface to be outputted to a display device, such as to report output server 204 as shown in FIG. 2, and/or data for a hardcopy document to be outputted by a report output device.

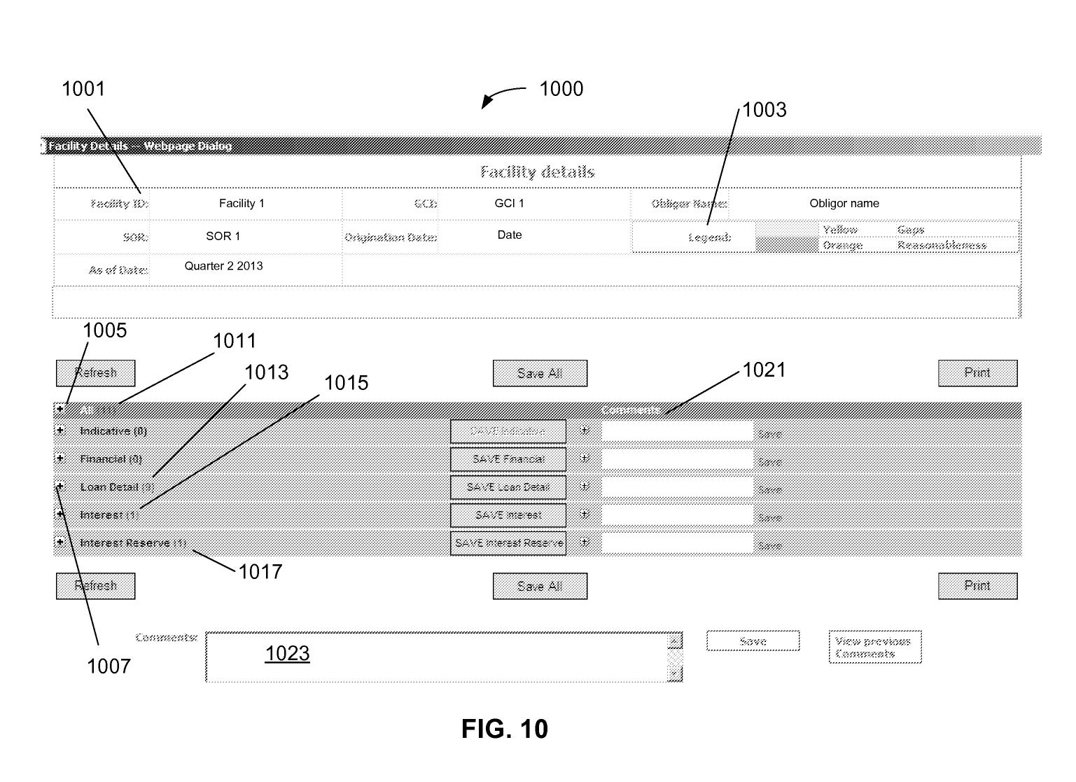

FIG. 10 is an illustrative user interface 1000 for reviewing and editing exceptions of a real estate loan offered by a financial institution on a particular real estate facility in accordance with at least one aspect of the present disclosure. Illustrative user interface 1000 may be a user interface outputted to a display device where a user has searched for details of a particular real estate facility. Identification data associated with a particular real estate facility may be shown with respect to reference element 1001. A legend 1003 may be included to identify suspect data element values and/or fatal data element values. In the example of FIG. 10, suspect data element values may be shown as highlighted yellow and fatal data element values may be shown as highlighted red. As described herein a fatal data element value may be one in which a user input to change the data element value is required while a suspect data element value may be one in which a user input to verify the data element value is requested and/or required.

Hierarchy expansion element 1005 allows a user to expand for different subsections associated with details of the real estate facility. As shown in the example in FIG. 10, reference element 1011 identifies “11” exceptions that have been identified by the system. Reference element 1011 may be a notification within user interface 1000 for a user to discern a total number of identified exceptions associated with this particular real estate facility. In addition, data may be included for identification of a particular category of the exception. For example, nine “Loan Detail” exceptions have been identified by reference element 1013, a single “Interest” exception has been identified by reference element 1015, and a single “Interest Reserve” exception has been identified with by reference element 1017 to make the total for all identified exceptions eleven as noted by reference element 1011. Comments with respect to one or more subsections may be included within comments field 1021. For example, upon review, verification, and/or modification of data element values within a subsection, a user may enter a comment in comments 1021 to identify the fact that analysis is complete. In addition, comments field 1023 allows for additional comments by user with respect to a particular real estate facility.

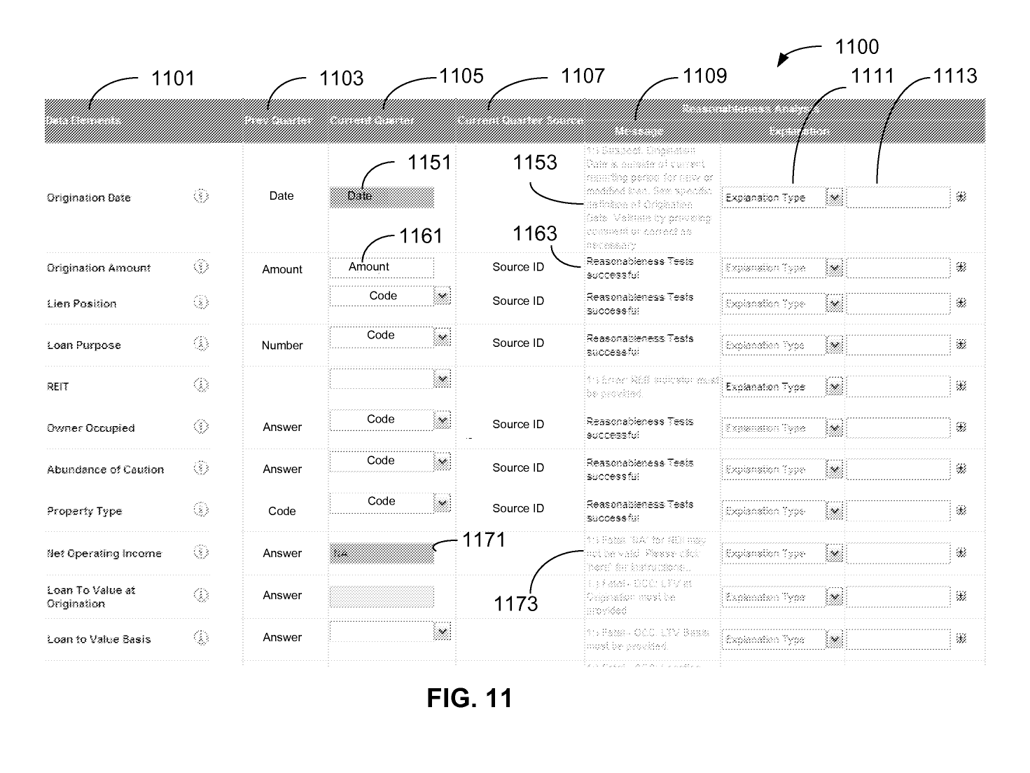

FIGS. 11-13 are illustrative user interfaces for loan details of a real estate loan offered by a financial institution on a particular real estate facility in accordance with at least one aspect of the present disclosure. User interface 1100 may be outputted on a display device in response to a user selecting hierarchy expansion element 1007 in FIG. 10. Individual details associated with a real estate loan for a particular facility may be shown. Any of a number of data elements 1101 may be included in a user interface 1100 showing the details. An origination date for the loan may be identified a current quarter entry 1151 for current quarter 1105 may be auto populated and/or received by user input. The data element value in entry field 1151 may be compared against the data entry value for the previous quarter 1103. Source for the entry for the current quarter 1105 the identified under current quarter source 1107. The current quarter source column 1107 may identify an origination for the data under the current quarter, 1105. The source for the entry for the current quarter may be by an individual and/or auto populated from an external database. A designation of “Source ID” may correspond to identification of a particular database and/or source from which the data was received and auto populated. Message column 1109 identifies whether the data element passes any business rule associated with the data element, whether the data element is blank, whether the data element is a fatal exception, and/or winter whether the data element is a suspect exception. A suspect exception may be one in which only verification of the input may be requested and/or required by an individual.

In the example of user interface 1100, message 1153 indicates that the entry 1151 for the origination date is a suspect exception. In response, a user may select an explanation type drop-down box 1111, and/or may include a comment in entry field 1113. For fatal exceptions, such as in message 1173 for data entry 1171, a user may not be able to select an explanation for the fatal exception and may be required to change the entry identified for the current quarter data entry 1171. In some examples, failure to change the data element value 1171 may prevent the system for generating a final port on the status of all real estate loans of the financial institution. The current quarter entry for the origination amount 1161 when compared to the entry for the previous quarter with respect to one or more business tools is found as meeting all business rules as shown in message 1163. As such, no need for an explanation type entry and/or comments by a user is needed.

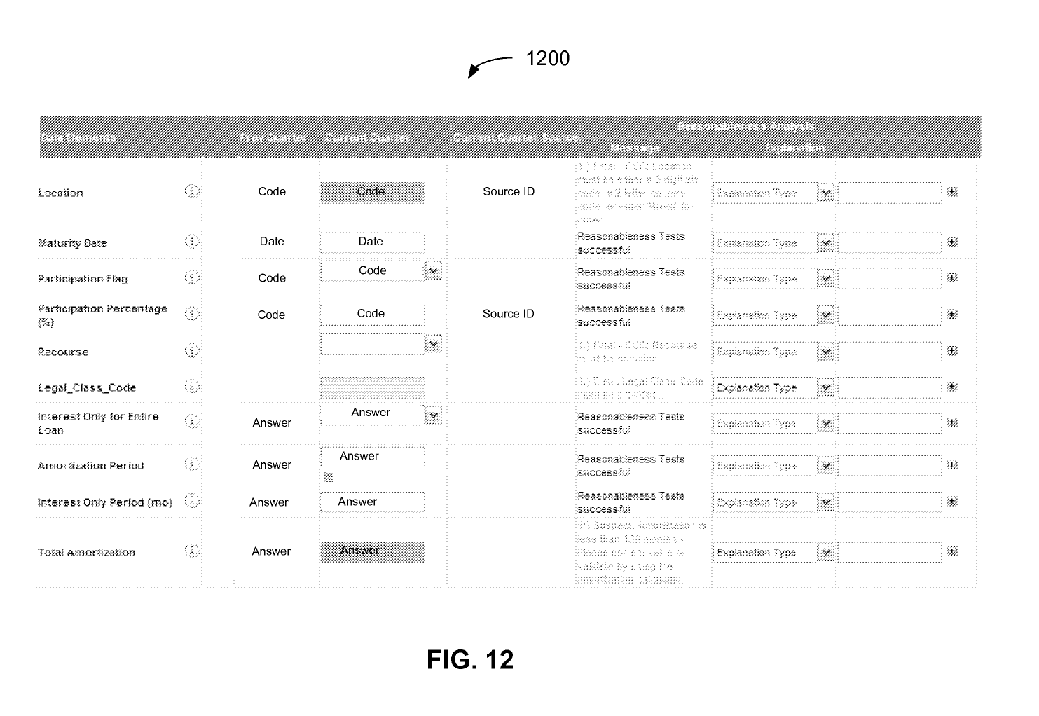

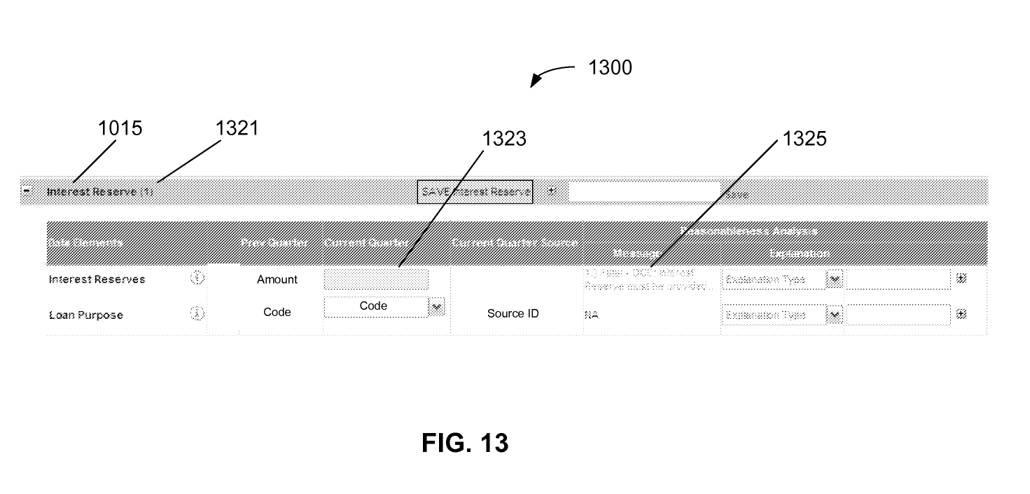

One or more data element values for a current quarter may be grayed out as being not relevant in response to entry of another data element value. In graying out a particular data element value, the system may be responding to a business rule associated with another data element specifying that the particular data element value should be grayed out. User interface 1200 shown in FIG. 12 may be a separate user interface and or may be additional data elements upon a user scrolling down on a list of data elements initially shown in user interface 1100 in FIG. 11. Again, any of a number of different data elements may be included herein. FIG. 13 includes a user interface 1300 corresponding to an “Interest Reserve” 1015 subsection as shown in FIG. 10. In user interface 1300, a single identified exception is identified by notification 1321. User interface 1300 shows to different data elements: “Interest Reserves” and “Loan Purpose.” In this example the data element value for the current quarter 1323 for “Interest Reserves” is blank. In response, the system in comparing against business rules associated with this data element may determine that a message 1325 may be needed for a user to input a value into entry field 1323. The system may require a user to enter a value for allowing for generation of a final status report and/or may generate a final status report noting that the entry field 1323 remains blank.

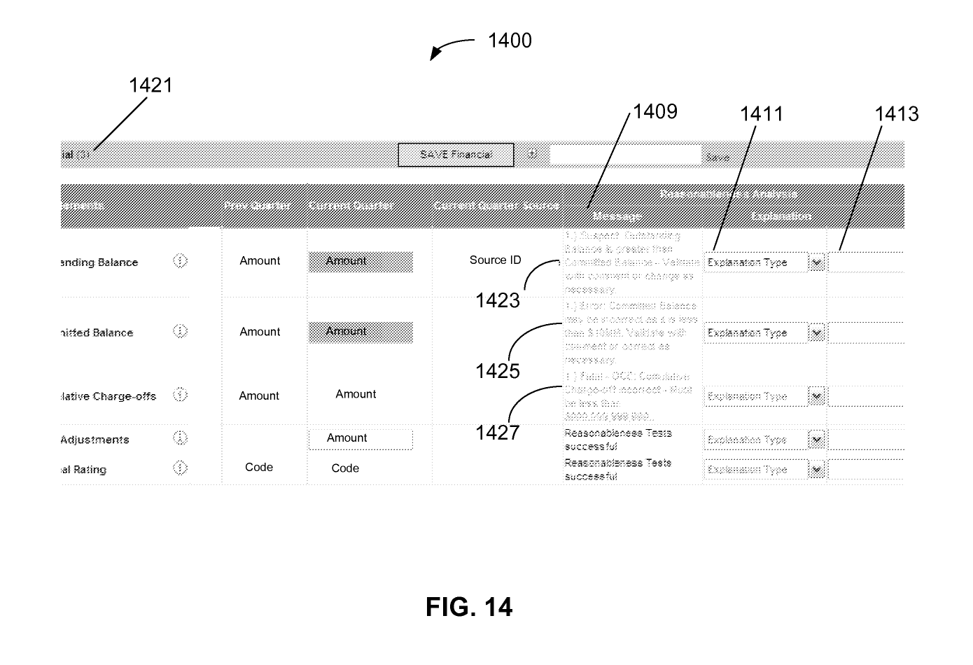

FIGS. 14-16 are illustrative user interfaces for reviewing and editing exceptions to data elements of a real estate loan offered by a financial institution on a particular real estate facility in accordance with at least one aspect of the present disclosure. FIGS. 14 to 16 illustrate an embodiment in which a user verifies that an entry for current quarter for a particular data element is correct although it may be in conflict with a business rule associated with the particular data element. User interface 1400 illustrates a notification 1421 identifying three identified exceptions. Under message column 1409, the three identified exceptions have three corresponding messages 1423, 1425, and 1427 associated therewith. In this example, the user may choose from and option of an explanation type at drop-down box entry field 1411 and or may enter a corresponding comment in entry field 1413. The user may be determined by the system to be authorized for entry of an explanation type and or comment to override a business rule associated with the particular data element.

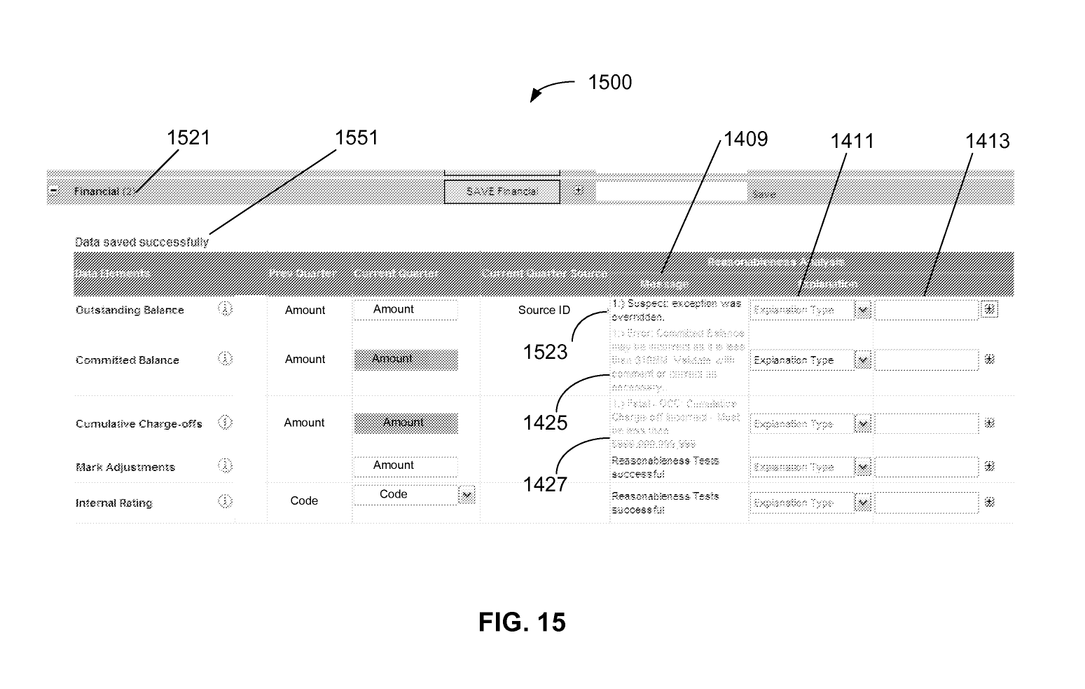

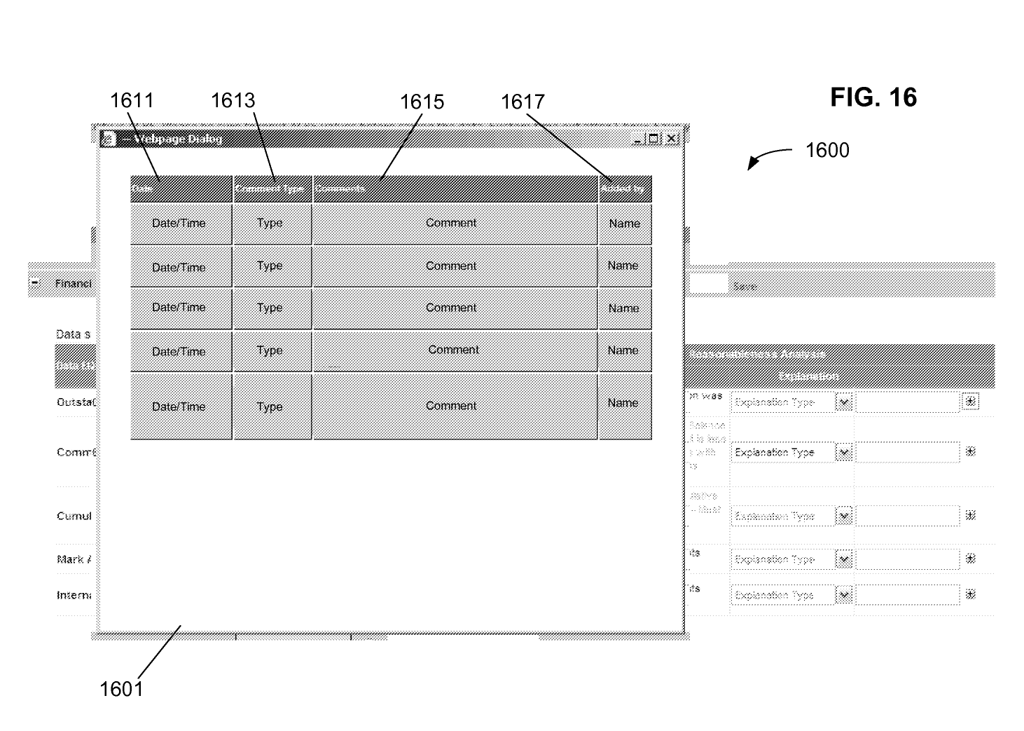

User interface 1500 shown in FIG. 15 illustrates an example where a user has verified an identified exception associated with the data element. As shown now, a notification 1521 identifies only to outstanding identified exceptions. Message 1551 identifies that data was successfully saved for noting that the identified exception for “Outstanding Balance” was overridden. Message 1523 identifies such. A user may now move to the next exception in order to change the data element value and/or verify the accuracy of the data element value according to the identified exception. User interface 1600 shown in FIG. 16 illustrates an example where a user requests to see changes associated with a particular data element, and/or a particular subsection. In this example, a separate window 1601 may be presented to a user on a display device. Entry data corresponding to a date and/or time 1611 a type of command inputted 1613 comments 1615 and by whom the addition was made 1617 may be shown. As such, a user may be able to discern who verified one or more identified exceptions and/or who changed data element values for one or more identified exceptions. As such, someone reviewing may identify why a change was made and/or the verification was authorized.

The disclosure is operational with numerous other general purpose or special purpose computing system environments or configurations. Examples of well known computing systems, environments, and/or configurations that may be suitable for use with the disclosure include, but are not limited to, personal computers, sever computers, hand-held or laptop devices, multiprocessor systems, microprocessor-based systems, set top boxes, programmable consumer electronics, network PCs, minicomputers, mainframe computers and distributed computer environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practices in distributed computing environments where tasks a performed by remote processing devices that are linked through a communication network. In a distributed computing environment, program modules may be located in both local and remote computer storage media including memory storage devices. The computer-executable instructions may be stored on non-transitory computer readable media, such as, but not limited to, a hard disk, a floppy disk, a flash drive, or other tangible computer readable media and memories.

Aspects of the present disclosure have been described in terms of illustrative embodiments thereof Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method comprising:
receiving first user input at a real estate loan processing computer, the first user input indicating a request for identifying at least one exception for data elements associated with at least one real estate loan of a plurality of real estate loans offered by a financial entity based on information specified in the request, the at least one exception representative of one of: a conditionally acceptable data element value or an unacceptable data element value;
retrieving, by at least one processor, from a loan data memory, data for the at least one real estate loan of the plurality real estate loans specified in the request;
retrieving, by at least one processor, from a rules data memory, business rules data concerning unconditionally acceptable values of the data for the at least one real estate loan specified in the request;
comparing, by at least one processor, data for the at least one real estate loan of the plurality of real estate loans specified in the request with the business rules data;
identifying the at least one exception for data elements associated with the at least one real estate loan based upon the comparison; and
receiving second user input at the real estate loan processing computer, the second user input indicating one of: a verification of the at least one exception for the conditionally acceptable data element value or a change of the value for the at least one exception for the unacceptable data element value.

2. The method of claim 1, further comprising populating, by at least one processor, in the loan data memory, data for the plurality of real estate loans offered by the financial institution, the data for the plurality of real estate loans populated from a plurality of databases.

3. The method of claim 2, further comprising populating, by at least one processor, in the rules data memory, business rules data comprising unconditionally acceptable values of the data for the plurality of real estate loans offered by the financial institution.

4. The method of claim 1, the comparing data for the at least one real estate loan of the plurality of real estate loans specified in the request with the business rules data includes determining the data for the at least one real estate loan does not satisfy the business rules data.

5. The method of claim 4, the identifying the at least one exception for data elements associated with the at least one real estate loan includes presenting a notification of the at least one exception in a user readable form.

6. The method of claim 5, wherein the at least one exception is representative of an unacceptable data element value, wherein the notification of the at least one exception includes a requirement for the change of the value for the unacceptable data element value.

7. The method of claim 5, wherein the at least one exception is representative of a conditionally acceptable data element value, wherein the notification of the at least one exception includes a request for the verification of the at least one exception.

8. The method of claim 1, wherein the at least one exception is representative of an unacceptable data element value and the second user input indicating the change of the value for the unacceptable data element value, the method further comprising:
populating, by at least one processor, in the loan data memory, data corresponding to the change of the value for the unacceptable data element value for the at least one real estate loan;
retrieving, by at least one processor, from the loan data memory, data, including the change of the value for the unacceptable data element value, for the at least one real estate loan of the plurality real estate loans specified in the request;
retrieving, by at least one processor, from the rules data memory, business rules data concerning unconditionally acceptable values of the data for the at least one real estate loan specified in the request; and
comparing, by at least one processor, data, including the change of the value for the unacceptable data element value, for the at least one real estate loan of the plurality of real estate loans specified in the request with the business rules data.

9. The method of claim 1, further comprising:
receiving third user input at the real estate loan processing computer, the third user input indicating a report request for generation of a report on a status of the at least one real estate loan of the plurality of real estate loans offered by the financial entity;
generating, by at least one processor, the report as specified in the report request; and
presenting the report in a user readable form.

10. An apparatus comprising:
a processor; and
a memory storing computer executable instructions that, when executed, cause the apparatus to perform a method comprising:
receiving first user input at a real estate loan processing computer, the first user input indicating a request for identifying at least one exception for data elements associated with at least one real estate loan of a plurality of real estate loans offered by a financial entity based on information specified in the request, the at least one exception representative of one of: a conditionally acceptable data element value or an unacceptable data element value;
retrieving, by at least one processor, from a loan data memory, data for the at least one real estate loan of the plurality real estate loans specified in the request;
retrieving, by at least one processor, from a rules data memory, business rules data concerning unconditionally acceptable values of the data for the at least one real estate loan specified in the request;
comparing, by at least one processor, data for the at least one real estate loan of the plurality of real estate loans specified in the request with the business rules data;
identifying the at least one exception for data elements associated with the at least one real estate loan based upon the comparison; and
receiving second user input at the real estate loan processing computer, the second user input indicating one of: a verification of the at least one exception for the conditionally acceptable data element value or a change of the value for the at least one exception for the unacceptable data element value.

11. The apparatus of claim 10, the comparing data for the at least one real estate loan of the plurality of real estate loans specified in the request with the business rules data includes determining the data for the at least one real estate loan does not satisfy the business rules data, and the identifying the at least one exception for data elements associated with the at least one real estate loan includes presenting a notification of the at least one exception in a user readable form.

12. The apparatus of claim 11, wherein the at least one exception is representative of an unacceptable data element value, wherein the notification of the at least one exception includes a requirement for the change of the value for the unacceptable data element value.

13. The apparatus of claim 11, wherein the at least one exception is representative of a conditionally acceptable data element value, wherein the notification of the at least one exception includes a request for the verification of the at least one exception.

14. The apparatus of claim 10, wherein the at least one exception is representative of an unacceptable data element value and the second user input indicating the change of the value for the unacceptable data element value, the computer executable instructions that, when executed, further cause the apparatus to perform a method comprising:
populating, by at least one processor, in the loan data memory, data corresponding to the change of the value for the unacceptable data element value for the at least one real estate loan;
retrieving, by at least one processor, from the loan data memory, data, including the change of the value for the unacceptable data element value, for the at least one real estate loan of the plurality real estate loans specified in the request;
retrieving, by at least one processor, from the rules data memory, business rules data concerning unconditionally acceptable values of the data for the at least one real estate loan specified in the request; and
comparing, by at least one processor, data, including the change of the value for the unacceptable data element value, for the at least one real estate loan of the plurality of real estate loans specified in the request with the business rules data.

15. The apparatus of claim 10, the computer executable instructions that, when executed, further cause the apparatus to perform a method comprising:
receiving third user input at the real estate loan processing computer, the third user input indicating a report request for generation of a report on a status of the at least one real estate loan of the plurality of real estate loans offered by the financial entity;
generating, by at least one processor, the report as specified in the report request; and
presenting the report in a user readable form.

16. A non-transitory computer readable medium storing computer readable instructions that, when executed, cause an apparatus to perform a method comprising:
receiving first user input indicating a request for identifying at least one exception for data elements associated with at least one real estate loan of a plurality of real estate loans offered by a financial entity based on information specified in the request, the at least one exception representative of one of: a conditionally acceptable data element value or an unacceptable data element value;
retrieving, from a loan data memory, data for the at least one real estate loan of the plurality real estate loans specified in the request;
retrieving, from a rules data memory, business rules data concerning unconditionally acceptable values of the data for the at least one real estate loan specified in the request;
comparing data for the at least one real estate loan of the plurality of real estate loans specified in the request with the business rules data;
identifying the at least one exception for data elements associated with the at least one real estate loan based upon the comparison; and
receiving second user input indicating one of: a verification of the at least one exception for the conditionally acceptable data element value or a change of the value for the at least one exception for the unacceptable data element value.

17. The non-transitory computer readable medium of claim 16, the comparing data for the at least one real estate loan of the plurality of real estate loans specified in the request with the business rules data includes determining the data for the at least one real estate loan does not satisfy the business rules data, and the identifying the at least one exception for data elements associated with the at least one real estate loan includes presenting a notification of the at least one exception in a user readable form.

18. The non-transitory computer readable medium of claim 17, wherein the at least one exception is representative of an unacceptable data element value, wherein the notification of the at least one exception includes a requirement for the change of the value for the unacceptable data element value.

19. The non-transitory computer readable medium of claim 16, wherein the at least one exception is representative of an unacceptable data element value and the second user input indicating the change of the value for the unacceptable data element value, the computer readable instructions, when executed, further cause the apparatus to perform a method comprising:
populating, in the loan data memory, data corresponding to the change of the value for the unacceptable data element value for the at least one real estate loan;
retrieving, from the loan data memory, data including the change of the value for the unacceptable data element value, for the at least one real estate loan of the plurality real estate loans specified in the request;
retrieving, from the rules data memory, business rules data concerning unconditionally acceptable values of the data for the at least one real estate loan specified in the request; and
comparing, data including the change of the value for the unacceptable data element value, for the at least one real estate loan of the plurality of real estate loans specified in the request with the business rules data.

20. A non-transitory computer readable medium storing computer readable instructions that, when executed, cause an apparatus to perform a method comprising:
receiving first user indicating a request for identifying exceptions for a plurality of data elements associated with a real estate loan offered by a financial entity, each exception representative of one of: a conditionally acceptable data element value, an unacceptable data element value, and an unconditionally acceptable data element value;
retrieving data element values for the plurality of data elements associated with the real estate loan, the data element values including data element values for a current period of time and data element values for a previous period of time;
retrieving business rules data concerning unconditionally acceptable values of the plurality of data elements associated with the real estate loan;
for each of the retrieved data element values for the plurality of data elements associated with the real estate loan, comparing the retrieved data element value with the business rules data to determine whether the retrieved data element value is an unconditionally acceptable value, the comparing including comparing the data element value for the current period of time to the data element value for the previous period of time;
identifying unconditionally acceptable data element values and the exceptions for the plurality of data elements associated with the real estate loan based upon the comparison;
for each identified exception, presenting a notification of the identified exception in a first user readable form;
for each identified unconditionally acceptable data element value, presenting a notification of the identified unconditionally acceptable data element value in a second user readable form;
for each identified exception, receiving a second user input indicating one of: a verification of the identified exception for a conditionally acceptable data element value or a change of the value for the identified exception for an unacceptable data element value;
for each verification of the identified exception, transmitting data of the verification with identification of the second user input to a loan data memory; and
for each change of the value of the data element for the identified exception, transmitting data of the value of the data element for the identified exception with identification of the second user input to the loan data memory.
